(19) United States
(12) Patent Application Publication
(10) Pub. No.: US 2024/0051800 A1
(43) Pub. Date: Feb. 15, 2024

(54) SNATCH ROLLER FAIRLEAD ASSEMBLIES AND ASSOCIATED SYSTEMS AND METHODS

(71) Applicant: MineSense Technologies Ltd., Vancouver (CA)

(72) Inventor: Kamyar Jafari-Esfahani, Vancouver (CA)

(21) Appl. No.: 18/449,588

(22) Filed: Aug. 14, 2023

Related U.S. Application Data
(60) Provisional application No. 63/397,758, filed on Aug. 12, 2022.

(51) Int. Cl. B66D 1/36

(52) U.S. Cl. CPC B66D 1/36

(57) ABSTRACT

Snatch roller fairlead assemblies for guiding cables and associated systems and methods are disclosed herein. In some embodiments, a snatch roller fairlead assembly includes a fairlead frame and a roller set including one or more rollers rotatably coupled to the fairlead frame. The rollers are configured to contact the cable from various directions and restrict the cable to a primarily bidirectional movement. The rollers can be coated with wear-resistant material to reduce wear on the rollers and the cable. The snatch roller fairlead assembly can be mounted to a structure via additional components attached to the fairlead frame that allow one or more degrees of freedom. In some embodiments, the snatch roller fairlead assembly can be mounted on a mining crane to guide a cable to a mining bucket.

### CROSS-REFERENCE TO RELATED APPLICATION(S)

The present application claims the benefit of U.S. Provisional Patent Application No. 63/397,758, filed Aug. 12, 2022, the disclosure of which is incorporated herein by reference in its entirety.

### TECHNICAL FIELD

The present disclosure generally relates to systems used to guide a cable or line and, in particular embodiments, to a snatch roller fairlead assembly for routing a mining equipment cable and associated methods and systems.

### BACKGROUND

Fairleads are used to guide and/or restrict lateral movement of cables, lines, ropes, or the like. For example, a fairlead can be a ring or a hook that routes a rope along a predefined path around an object, elevate the cable or line from the ground, and/or otherwise restrict lateral movement of the cable or line routed therethrough.

### BRIEF DESCRIPTION OF THE DRAWINGS

Many aspects of the present disclosure can be better understood with reference to the drawings in the following Detail Description. The components in the drawings are not necessarily to scale. Instead, emphasis is placed on clearly illustrating the principles of the present disclosure.

FIGS. 1A-1C are perspective, front, and side views, respectively, of a snatch roller fairlead assembly configured in accordance with embodiments of the present technology.

FIG. 2 is a perspective view of a side roller of the snatch roller fairlead assembly of FIGS. 1A-1C configured in accordance with embodiments of the present technology.

FIG. 3A is a perspective view of a crane system including a snatch roller fairlead assembly configured in accordance with embodiments of the present technology.

FIG. 3B is an enlarged perspective view of the snatch roller fairlead assembly of FIG. 3A configured in accordance with embodiments of the present technology.

### DETAILED DESCRIPTION

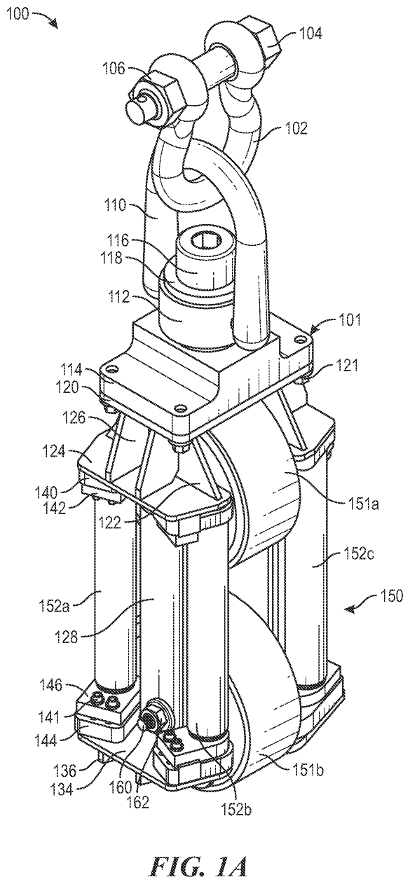

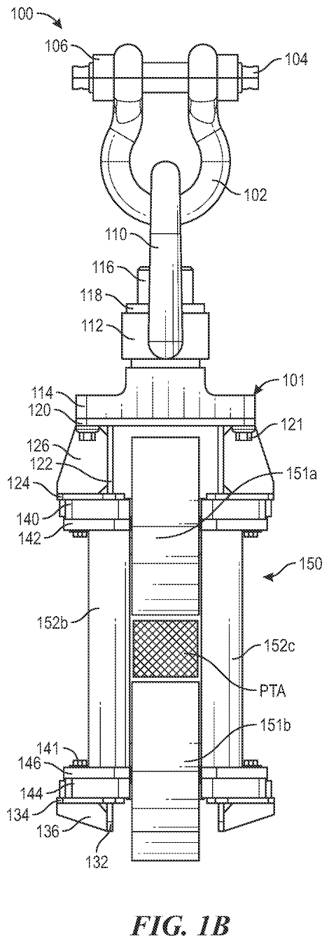

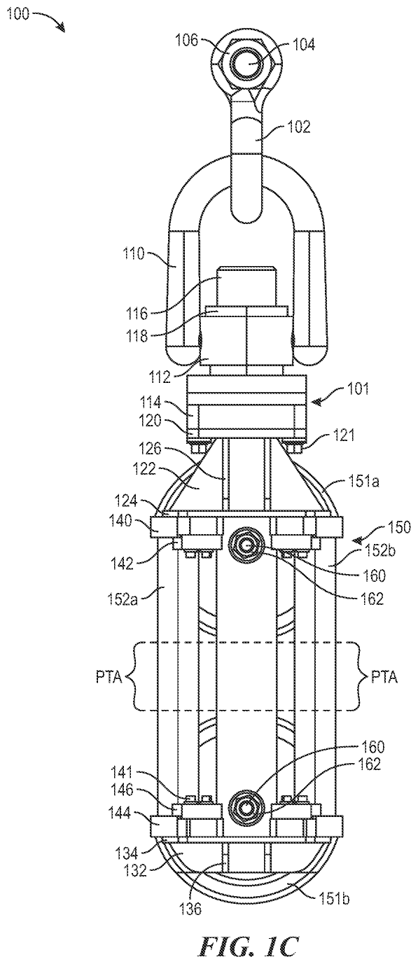

The present technology is directed generally to snatch roller fairlead assemblies for guiding cables and the like, and associated systems and methods. In some embodiments, for example, a snatch roller fairlead assembly can include a plurality of rollers positioned and oriented to engage a cable from various directions and to restrict lateral movement of the cable and provide for only bidirectional movement through the snatch roller fairlead assembly. Specific details of several embodiments of the present technology are described herein with reference to FIGS. 1A-3B. The present technology, however, can be practiced without some of these specific details. In some instances, well-known structures and techniques often associated with mining equipment have not been shown in detail so as not to obscure the present technology. The terminology used in the description presented below is intended to be interpreted in its broadest reasonable manner, even though it is being used in conjunction with a detailed description of certain specific embodiments of the disclosure. Certain terms can even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements can be arbitrarily enlarged to improve legibility. Component details can be abstracted in the Figures to exclude details such as position of components and certain precise connections between such components when such details are unnecessary for a complete understanding of how to make and use the present technology. Many of the details, dimensions, angles, and other features shown in the Figures are merely illustrative of particular embodiments of the disclosure. Accordingly, other embodiments can have other details, dimensions, angles, and features without departing from the spirit or scope of the present technology.

The following disclosure describes various embodiments of and associated systems, components, and methods for use with, for example, industrial mining equipment and/or rugged sensors associated with the mining equipment. The snatch roller fairlead assemblies configured in accordance with the present technology can be mounted to a surface or component of a piece of mining equipment (e.g., a mining shovel boom, mining shovel bucket, various linkage, a bucket arm, a dipper handle, a main cabin) and route one or more cables between two components that move relative to each other. For example, the snatch roller fairlead assemblies disclosed herein can be mounted along a boom of a mining shovel to route a cable between the upper mining shovel assembly and a device positioned on the mining shovel bucket (also referred to as a “dipper”). In operation, the snatch roller fairlead assemblies disclosed herein can facilitate the bidirectional movement of the cable while reducing the strain on the cable. This can be of particular importance when the snatch roller fairlead assemblies are used to route electrical cables that connect to sensors, cameras, and/or other components positioned on a movable portion of the mining equipment (e.g., a mining shovel bucket).

As used herein, the term “cable” can refer to various types of cables (e.g., electrical, fiber optic, metallic, coaxial, etc.), lines, ropes, string, and/or other elongated structures that are used to mechanically and/or electrically connect two structures and move relative thereto. These cables may include shielding, sheathing, other types of coverings and/or coatings, and/or one or more of these coverings or coatings may be omitted. Embodiments of the snatch roller fairlead assemblies described herein can be used with various cable or line sizes and/or materials, and some embodiments of the snatch roller fairlead assemblies may be designed to work with two or more different types of cables or lines (at the same time or separately).

FIGS. 1A-1C are perspective, front, and side views, respectively, of a snatch roller fairlead assembly 100 (“assembly 100”) configured in accordance with embodiments of the present technology. The assembly 100 includes a mounting subassembly 103 for connecting the assembly 100 to another structure or surface and a fairlead subassembly 105 carried by the mounting subassembly 103 and configured to route a cable in a bidirectional manner. The fairlead subassembly 105 includes a fairlead frame 101 that supports a roller set 150 comprising a plurality of control rollers 151 (referred to individually as first and second control rollers 151a and 151b, respectively) and side rollers 152 (referred to individually as first through fourth side rollers 152a-152d, respectively).

The mounting subassembly 103 can include features for attaching the assembly 100 to another structure or surface, such as to a portion of a mining shovel. In some embodiments, the mounting subassembly 103 can include features that allow the fairlead frame 101 to rotatably couple to another structure. The mounting subassembly 103 can include a mounting component 102, which may be a shackle, a bracket, a tab, a hanger, clamps, mounting plates, interlocking surfaces, and/or other connection mechanism. In the embodiment illustrated in FIGS. 1A-1C, the mounting component 102 is a shackle with a U-shape that allows the assembly 100 to be suspended from another structure, though in other embodiments the mounting component 102 may have a different shape, such as a circular, oval, triangular, rectangular, or other shape. The mounting component 102 can include one or more apertures configured to receive a fastener 104, such as a screw, pin, or other type of shaft, which can then be secured therein (e.g., with one or more nuts 106). The fastener 104 can be inserted into an aperture or hook (not shown) on the surface to which the assembly 100 is mounted. This arrangement allows the mounting component 102 to rotate about an axis defined by a length of the fastener 104. In some embodiments, the mounting component 102 can be fixedly coupled to the surface or other structure (e.g., by providing a tight fit between the fastener 104 and the aperture or hook on the surface or other structure). In some embodiments, the mounting component 102 can be coupled to the surface or other structure via other connection methods (e.g., welding, adhesives). In some embodiments, the mounting component 102 can be omitted and the assembly 100 can be integrally formed with a portion of the surface or other structure to suspend the assembly therefrom.

The mounting subassembly 103 can further include a hoist ring component 110 coupled to the mounting component 102 at a portion spaced apart from (e.g., opposite) the fastener 104. For example, before the fastener 104 has been inserted through the apertures of the mounting component 102, a bail 111 of the hoist ring component 110 can be positioned to extend around the mounting component 102 in an interlocking manner. The hoist ring component 110 includes the bail 111 mounted to a hoist ring body 112 (also referred to as an “articulatable member 112” or “body 112”) via a pin or other connector, and a fastener 116 (e.g., a screw, bolt) that connects the hoist ring component 110 to the fairlead frame 101. For example, the body 112 can have a hole extending therethrough that receives the fastener 116, and the fastener 116 can extend entirely through the body 112 into a corresponding aperture in the fairlead frame 101 and secured thereto (e.g., screwed together). For example, the bail 111 can coupled to the hoist ring body 112 via, for example, a pin (not shown), and the bail 111 can rotate about the pin. In various embodiments, the bail 111 can have a shape different from the illustrated U-shape, such as a circular, oval, triangular, rectangular, or other shape. In some embodiments, the mounting component 102 can be omitted and the hoist ring component 110 can be directly coupled to the surface or other structure to suspend the assembly therefrom.

In some embodiments, the hoist ring component 110 can be what is known as a “swivel hoist ring” and is configured to rotate relative to the fairlead frame 101. For example, the fastener 116 can be fixed relative to the fairlead frame 101 and the hoist ring body 112 can include a bearing member to allow rotation of the hoist ring component 110 relative to the fastener 116 and the fairlead frame 101 about an axis defined by a length of the fastener 116. In some embodiments, a washer 118 can be included between the fastener 116 and the hoist ring body 112 to reduce abrasion therebetween.

The fairlead frame 101 includes a plurality of support members that are sized, shaped, and arranged in a manner to support the roller set 150. In the embodiment illustrated in FIGS. 1A-1C, for example, the fairlead frame 101 includes a body portion 114 coupled to the hoist ring component 110, a base plate 120 attached to the body portion 114, a plurality of web components 122, upper support plates 124 (also referred to as “first support plates 124”), a plurality of gussets 126, central web components 128, first roller blocks 140 (also referred to as “upper roller blocks 140”), first bearing brackets 142 (also referred to as “upper bearing brackets 142”), lower support plates 134 (also referred to as “second support plates 134”), second roller blocks 144 (also referred to as “lower roller blocks 144”), and second bearing brackets 146 (also referred to as “lower bearing brackets 146”). The body portion 114 can be coupled to the hoist ring body 112 via the fastener 116. The base plate 120 can be coupled to the body portion 114 via fasteners 121. On each side of the fairlead frame 101, the upper support plate 124, which extends generally parallel to the base plate 120, can be coupled to the base plate 120 via the web component 122, which extends generally perpendicular to the base plate 120. The gussets 126 can be coupled to the web component 122 and the upper support plate 124 to provide additional structural support.

Further on each side of the fairlead frame 101, the central web component 128 can extend between the upper support plate 124 and the lower support plate 134, which extends generally parallel to the upper support plate 124. The web component 122 can be coupled to the lower support plate 134 while extending generally perpendicular to the lower support plate 134. The gussets 126 can be coupled to the web component 122 and the lower support plate 134 to provide additional structural support. In the illustrated embodiment, two first roller blocks 140 are coupled to each of the upper support plates 124, and each first bearing bracket 142 is coupled to each first roller block 140. Similarly, two second roller blocks 144 are coupled to each of the lower support plates 134, and each second bearing bracket 146 is coupled to each second roller block 144. The upper and lower support plates 124, 134, the first and second roller blocks 140, 144, and the first and second bearing brackets 142, 146 can be coupled via fasteners 141.

In some embodiments, the fairlead frame 101 can include fewer support components, more support components, and/or different support components. In some embodiments, the various components of the fairlead frame 101 can be attached via welding, bonding, mechanical fastening, or other suitable coupling mechanisms. In some embodiments, one or more of the various components of the fairlead frame 101 can be integrally formed. The various components of the fairlead frame 101 can be made from steel (e.g., ASTM A514, other structural grade steel), composites, sheet metal, and/or other materials via casting, additive manufacturing (e.g., 3D printing), machining, etc., and/or can be used in conjunction with one or more portions comprising a sheet material. The fairlead frame 101 can be any suitable size to accommodate various cable routing requirements, such as for mining equipment. In some embodiments, the distance between outer edges of the upper support plates 124 on either side of the fairlead frame 101 can range between 220 millimeters (mm) and 280 mm (e.g., 247 mm).

The first control roller 151a can be rotatably coupled between upper portions of the two central web components 128, and the second control roller 151b can be rotatably coupled between lower portions of the two central web components 128, each via fasteners 160 and nuts 162. In some embodiments, the control rollers 151 can be rotatably coupled to the central web components 128 via bearing members or other coupling mechanisms. The control rollers 151 can be positioned such that they do not contact other surfaces of the fairlead frame 101, such as the base plate 120 or the side rollers 152 to reduce or minimize abrasion. In some embodiments, the first and second control rollers 151a, 151b can be separated by a distance ranging between 60 mm and 90 mm (e.g., 76.2 mm).

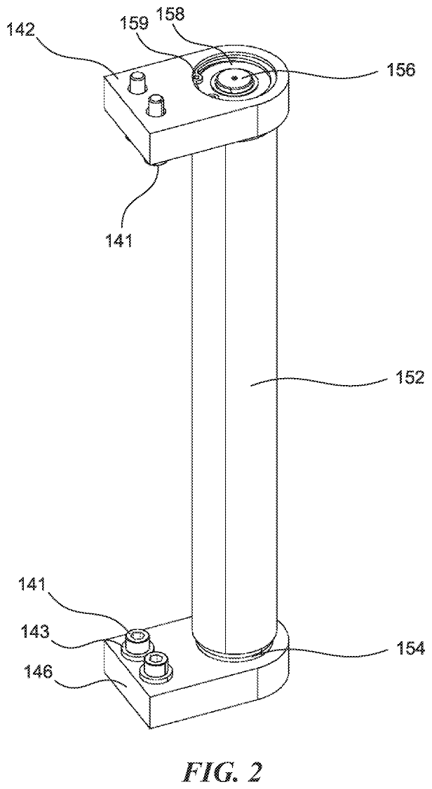

Each side roller 152 can be coupled between the first and second bearing brackets 142, 146. The connection of each side roller 152 to the first and second bearing brackets 142, 146 is described in further detail below with respect to FIG. 2. The side rollers 152 can be positioned such that they are free to rotate without contacting other neighboring surfaces, such as the central web components 128 and the control rollers 151.

In some embodiments, the roller set 150 can include fewer or more control rollers 151 and/or side rollers 152. For example, the roller set 150 can include one, two, three, four, five, six, seven, eight, nine, ten, or more control rollers 151 and/or side rollers 152. In embodiments in which the roller set 150 includes two side rollers 152, one side roller 152 can be positioned on either side of the control rollers 151 and closer to the central web components 128 than illustrated in FIGS. 1A and 1C.

In some embodiments, the control rollers 151 and the side rollers 152 can be made from plastic (e.g., polyurethane, ultra-high molecular weight polyethylene (UHMW)), steel (e.g., ASTM A514, other structural grade steel), aluminum, composites, and/or other materials via casting, additive manufacturing (e.g., 3D printing), machining, etc. Each of the control rollers 151 and the side rollers 152 can be any suitable size (e.g., greater or smaller diameter, length, and/or thickness) to accommodate various cable routing requirements, such as for mining equipment.

In operation, the assembly 100 can be mounted to a surface or other structure via the mounting subassembly 103. The mounting subassembly 103 can provide one or more degrees of freedom. For example, in some embodiments, the mounting component 102 can provide one rotational degree of freedom by rotating about the fastener 104. In some embodiments, the bail 111 can provide two rotational degrees of freedom by being interlocked with the mounting component 102 (e.g., a first degree of freedom by rotating in a clockwise or counterclockwise direction when viewed from the front as shown in FIG. 1B, and a second degree of freedom by rotating in a clockwise or counterclockwise direction when viewed from the side as shown in FIG. 1C). Other degrees of freedom are also possible with respect to the mounting component 102. In some embodiments, the pinned coupling between the bail 111 and the hoist ring body 112 can provide one rotational degree of freedom by rotating in a clockwise or counterclockwise direction when viewed from the front as shown in FIG. 1B. Furthermore, the hoist ring body 112 can provide an additional rotational degree of freedom by allowing the body portion 114 to rotate about an axis extending through the fastener 116.

Before, during, or after the assembly 100 is mounted to the surface or other structure, a cable can be inserted into the pass-through-area (“PTA,” illustrated in FIGS. 1B and 1C). As shown, the first and second control rollers 151a and 151b define the upper and lower boundaries of the PTA, respectively, and the side rollers 152 define the side boundaries of the PTA. During bidirectional movement of the cable (e.g., when applying tension in the cable to lift a bucket attached to a crane arm and the cable), interaction with the outer surface of the cable can cause one or both of the control rollers 151 and/or one or more of the side rollers 152 to rotate with respect to the fairlead frame 101 to avoid imparting excessive friction to the outer surface of the cable. In some embodiments, the cable can have a large enough diameter such that all of the control rollers 151 and the side rollers 152 contact and roll against the cable.

In some embodiments, the cable can include steel coating, braided jackets, braided cable sleeving made from steel, or other protective outer layer. In some embodiments, at least a portion of the surfaces of the control rollers 151 and/or the side rollers 152 adjacent to the PTA are coated with a wear-resistant material (e.g., polyurethane, polyoxymethylene thermoplastic, rubber, or the like) to further reduce wear on the cable. In some embodiments, the control rollers 151 and/or the side rollers 152 can include friction-reducing features (e.g., as will be described in further detail below with respect to FIG. 2) to facilitate rotation of the control rollers 151 and/or the side rollers 152 as the cable moves with respect to the assembly 100.

FIG. 2 is a perspective view of one of the side rollers 152 configured in accordance with embodiments of the present technology. As shown, the side roller 152 can include a first end portion 156 that can be necked down and configured to extend within and interface with a bearing 158 (e.g., a roller bearing) that is retained within the upper bearing bracket 142 by a clip 159 (e.g., a circlip). In some embodiments, the lower bearing bracket 146 can also include a similar bearing configuration for interfacing with a second end portion (not shown) of the side roller 152 opposite the first end portion 156. In some embodiments, each side roller 152 can include transition portions 154 proximate to each of the first end portion 156 and the second end portion. The transition portions 154 can provide clearance between the side roller 152 (and/or wear-resistant material on the side roller 152) and each of the upper and lower bearing brackets 142, 146 (and/or the bearing 158) to avoid contact therebetween. Abrasion between the components can induce wear and increase the required force applied on the cable to rotate the side rollers 152, which may also increase friction on the outer surface of the cable.

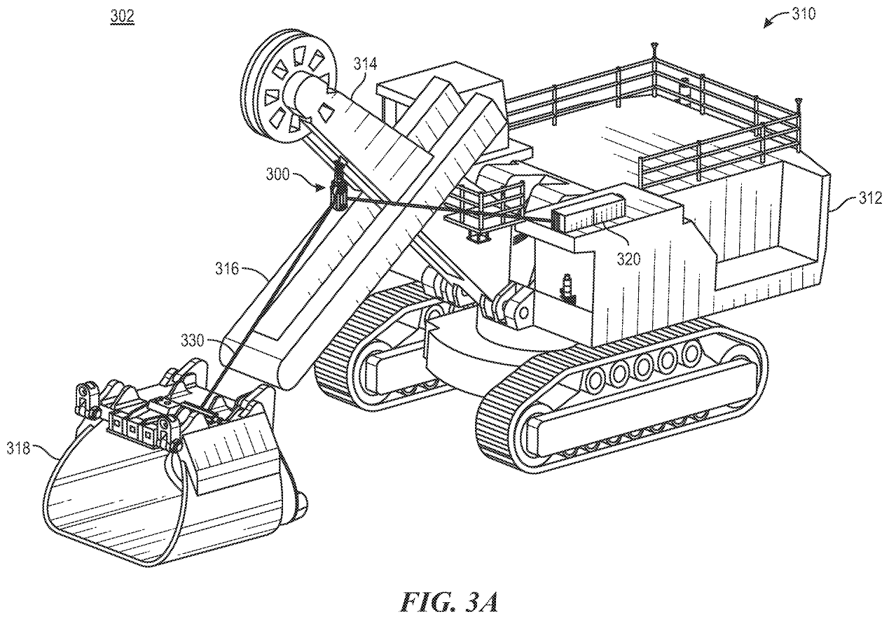

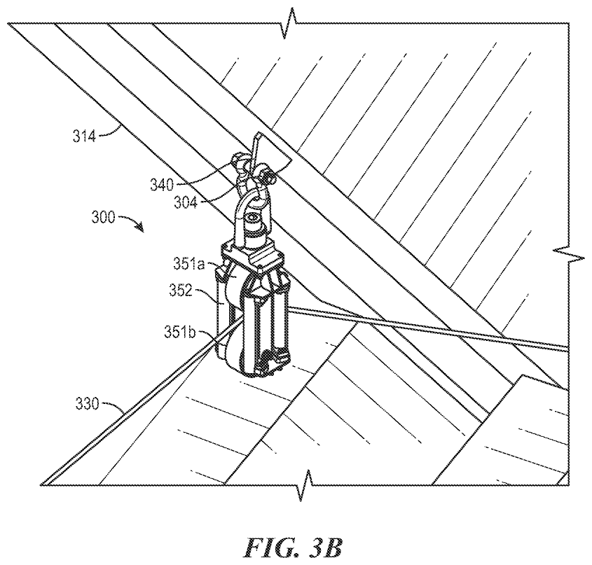

FIG. 3A is a perspective view of a mining shovel system 302 (“system 302”) configured in accordance with embodiments of the present technology. The system 302 can include a mining shovel 310, a snatch roller fairlead assembly 300 (“assembly 300”) attached to the mining shovel 310, a cable slack control system 320, and a cable 330. The mining shovel 310 includes a shovel body 312 (also referred to as “stationary portion 312”), a boom 314 extending from the shovel body 312, a shovel arm 316 coupled to boom 314, and a movable bucket 318 coupled to the shovel arm 316. The assembly 300 can be an example of the assembly 100 discussed above with respect to FIGS. 1A-C. The cable 330 can extend from the shovel body 312 through the cable slack control system 320 (portion of the cable 330 extending therebetween not shown), through the assembly 300, and to the bucket 318. In the illustrated embodiment, the assembly 300 is mounted to an underside of the boom 314. In other embodiments, the assembly 300 can be mounted elsewhere (e.g., side surface of the boom 314, the shovel body 312, the shovel arm 316, etc.). In some embodiments, the cable slack control system 320 is omitted from the system 302.

In some embodiments, the assembly 300 can guide the cable 330 between the shovel body 312 and the bucket 318 to extend the usable length of the cable 330 when the bucket 318 moves away from the shovel body 312 via the boom 314 and/or the shovel arm 316. In some embodiments, the cable slack control system 320 can be used in conjunction with the assembly to automatically pick up any slack in the cable 330 as the bucket 318 moves closer to the shovel body 312. The slack adjustment keeps the cable 330 taught while the assembly 300 keeps the cable 330 away from the ground throughout the range of motion of the bucket 318.

In some embodiments, the cable 330 can comprise a rope or other line configured to move the bucket 318 relative to the shovel arm 316. In some embodiments, the cable 330 can comprise an electrical cable connected to various electrical components (e.g., sensors, processors, light source, mining equipment) on the bucket 318 for supplying power, transferring data, transmitting signals, etc. In some embodiments, the electrical components can include sensors configured to measure characteristics in the bucket 318. In some embodiments, the sensors on the bucket 318 can include a multispectral or hyperspectral imaging head as described in U.S. patent application Ser. No. 17/992,626, entitled COMPOSITIONAL MULTISPECTRAL AND HYPERSPECTRAL IMAGING SYSTEMS FOR MINING SHOVELS AND ASSOCIATED METHODS, filed Nov. 22, 2022, and/or the sensors shown and described in U.S. Pat. Nos. 9,522,415, 10,036,142, and 10,982,414, each titled MINING SHOVEL WITH COMPOSITIONAL SENSORS, which are incorporated by reference herein in their entirety.

It can be important to avoid applying excessive force (e.g., tension, lateral force) on the cable 330, such as when the cable 330 is an electrical cable. It can also be important to avoid having excessive slack, as such slack can cause the cable 330 to contact and/or entangle with other components of the system 302, the terrain, structures, and/or objects moving about the environment (e.g., a mining environment), which can cause chafing, abrading, and/or severing of the cable 330.

FIG. 3B is an enlarged perspective view of the assembly 300 configured in accordance with embodiments of the present technology. In the illustrated embodiment, the assembly 300 is mounted to a connector component 340 attached to the boom 314 via fasteners 304 (e.g., the fastener 104). The cable 330 can extend between a first control roller 351a (e.g., the first control roller 151a), a second control roller 351b (e.g., the second control roller 151b), and one or more side rollers 352 (e.g., the side rollers 152). The first and second control rollers 351a, 351b can restrict vertical movement of the cable 330, while the side rollers 352 can restrict lateral movement of the cable 330. As a result, the cable 330 can move bidirectionally through the assembly 300. In some embodiments, the assembly 300 can include one or more degrees of freedom relative to the connector component 340, as described above with respect to the assembly 100 in FIGS. 1A-C. For example, when a lateral force is applied on the cable 330, the cable 330 can remain between the rollers 351a, 351b, 352, and the assembly 300 can swing or rotate in the direction of the applied lateral force. The degrees of freedom allow the assembly 300 to generally guide the cable 330 bidirectionally while reducing the mechanical load applied to the assembly 300, thereby reducing the risk of mechanical failure of components of the assembly 300, the connector component 340, etc.

### Further Examples

The following examples are illustrative of several embodiments of the present technology:

1. A snatch roller fairlead assembly for mining equipment, comprising:
a fairlead frame comprising—
   a first upper support plate;
   a first lower support plate spaced apart from the first upper support plate;
   a first web having a first end portion coupled to the first upper support plate and a second end portion coupled to the first lower support plate;
   a second upper support plate spaced apart from the first upper support plate;
   a second lower support plate spaced apart from the second upper support plate; and
   a second web having a first end portion coupled to the second upper support plate and a second end portion coupled to the second lower support plate;
a mounting subassembly coupled to the fairlead frame, wherein the mounting subassembly is configured to attach the fairlead frame to a portion of the mining equipment; and
a roller set carried by the fairlead frame and configured to receive a cable, the roller set comprising—
   a first control roller rotatably coupled between the first and second webs and positioned proximate the first and second support plates;
   a second control roller rotatably coupled between the first and second webs and positioned proximate the first and second lower support plates, wherein the first and second control rollers are spaced apart by a distance to receive the cable therebetween and rotate to allow bidirectional movement of the cable;
   a first side roller rotatably coupled between the first upper support plate and first lower support plate; and
   a second side roller rotatably coupled between the second upper support plate and second lower support plate, wherein the first and second side rollers are configured to restrict lateral movement of the cable.

2. The assembly of any one of the preceding examples wherein the roller set further comprises:
a third side roller rotatably coupled between the first upper and first lower support plates, wherein the first web is positioned between the first and third side rollers; and
a fourth side roller rotatably coupled between the second upper and second lower support plates, wherein the second web is positioned between the second and fourth side rollers.

3. The assembly of any one of the preceding examples wherein at least a portion of the fairlead frame is made from structural steel.

4. The assembly of any one of the preceding examples wherein the upper control roller, the lower control roller, the first side roller, and/or the second side roller are made from ultra-high molecular weight polyethylene (UHMW).

5. The assembly of any one of the preceding examples wherein the upper control roller, the lower control roller, the first side roller, and/or the second side roller are made from steel.

6. The assembly of any one of the preceding examples wherein the upper control roller, the lower control roller, the first side roller, and/or the second side roller comprise a surface at least partially coated with a wear-resistant material.

7. The assembly of any one of the preceding examples wherein the first side roller comprises:
a first end portion coupled to a first bearing retained within an upper bearing bracket coupled to the first upper support plate, the first end portion having a first transition portion to provide clearance between the first side roller and the upper bearing bracket; and
a second end portion coupled to a second bearing retained within a second bearing bracket coupled to the first lower support plate, the second end portion having a second transition portion to provide clearance between the first side roller and the lower bearing bracket.

8. The assembly of any one of the preceding examples wherein:
the fairlead frame further comprises a base plate coupled to the first and second upper support plates; and
the mounting subassembly comprises a hoist ring component coupled to the base plate, wherein the hoist ring component is configured to rotate relative to the fairlead frame.

9. The assembly of any one of the preceding examples wherein the mounting subassembly comprises:
a mounting component configured to suspend the fairlead frame from the portion of the mining equipment; and
a hoist ring component having a first end portion coupled to the mounting component and a second end portion coupled to the fairlead frame.

10. A cable routing system, comprising:
a cable having a first end configured to be coupled to a stationary portion of a mining shovel and a second end configured to be coupled to a movable bucket of the mining shovel; and
a snatch roller fairlead assembly configured to be coupled between the stationary portion and the movable bucket, wherein the snatch roller fairlead assembly comprises:
   a fairlead frame including:
      a base plate;
      an upper support plate coupled to a lower side of the base plate;
      a lower support plate spaced apart from the upper support plate;
      a web coupled and extending between the upper support plate and the lower support plate;
   a roller set coupled to the fairlead frame, the roller set including:
      a first control roller rotatably coupled to the web and positioned proximate to the upper support plate;
      a second control roller rotatably coupled to the web and positioned proximate to the lower support plate; and
      a side roller rotatably coupled between the upper and lower support plates;
wherein the cable is configured to extend between the upper and lower control rollers and adjacent to the side roller.

11. The system of any one of the preceding examples wherein the snatch roller fairlead assembly further comprises a mounting subassembly coupled to the fairlead frame, wherein the mounting subassembly is configured to attach the fairlead frame to the mining shovel.

12. The system of any one of the preceding examples wherein the cable is an electrical cable configured to be operatively coupled to transfer power and/or signals to/from an electrical component.

13. The system of example 12 wherein the electrical component includes a sensor configured to measure characteristics in the movable bucket of the mining shovel.

14. The system of any one of the preceding examples wherein the cable comprises a braided cable sleeving made from steel.

15. The system of any one of the preceding examples wherein the upper support plate is a first upper support plate, wherein the lower support plate is a first lower support plate, wherein the web is a first web, wherein the side roller is a first side roller, wherein the fairlead frame further includes:
a second upper support plate coupled to a lower side of the base plate and spaced apart from the first upper support plate;
a second lower support plate spaced apart from the second upper support plate; and
a second web coupled and extending between the second upper support plate and the second lower support plate,
wherein the roller set further includes a second side roller rotatably coupled between the second upper and second lower support plates, and
wherein the cable is configured to extend between the first and second side rollers.

16. A method of routing a cable, comprising:
mounting a snatch roller fairlead assembly to a mining shovel, wherein the snatch roller fairlead assembly includes:
   a first web;
   a second web spaced apart from the first web.
   a first control roller rotatably coupled between the first and second webs;
   a second control roller rotatably coupled between the first and second webs and spaced apart from the first control roller;
   a first side roller extending parallel and proximate to the first web; and
   a second side roller extending parallel and proximate to the second web; and
routing a cable between the first and second control rollers and between the first and second side rollers.

17. The method of any one of the preceding examples wherein the mining shovel includes a bucket, wherein the cable includes an electrical cable, the method further comprising:
operatively coupling the cable to an electrical component mounted on the bucket; and
transferring power and/or signals to/from the electrical component through the cable.

18. The method of any one of the preceding examples wherein the cable includes a braided cable sleeving, and wherein the first control roller, the second control roller, the first side roller, and/or the second side roller is at least partially coated with a wear-resistant material.

19. The method of any one of the preceding examples, further comprising:
moving the cable through the snatch roller fairlead assembly, thereby causing at least one of the first control roller, the second control roller, the first side roller, or the second side roller to roll against the cable.

20. The method of any one of the preceding examples wherein the snatch roller fairlead assembly further comprises a mounting subassembly coupled to the fairlead frame, wherein the mounting subassembly is configured to attach the first web to the mining shovel.

### CONCLUSION

In general, the detailed description of embodiments of the present technology is not intended to be exhaustive or to limit the invention to the precise form disclosed above. While specific embodiments of, and examples for, the present technology are described above for illustrative purposes, various equivalent modifications are possible within the scope of the present technology, as those skilled in the relevant art will recognize.

The teachings of the present technology provided herein can be applied to other systems, not necessarily the system described herein. The elements and acts of the various embodiments described herein can be combined to provide further embodiments.

Any patents, applications and other references, including any that may be listed in accompanying filing papers, are incorporated herein by reference. Aspects of the present technology can be modified, if necessary, to employ the systems, functions, and concepts of the various references described above to provide yet further embodiments of the present technology.

These and other changes can be made to the present technology in light of the above Detailed Description. While the above description details certain embodiments of the present technology and describes the best mode contemplated, no matter how detailed the above appears in text, the present technology can be practiced in many ways. Details of the present technology may vary considerably in its implementation details, while still being encompassed by the present technology disclosed herein. As noted above, particular terminology used when describing certain features or aspects of the present technology should not be taken to imply that the terminology is being redefined herein to be restricted to any specific characteristics, features, or aspects of the present technology with which that terminology is associated. In general, the terms used in the following claims should not be construed to limit the present technology to the specific embodiments disclosed in the specification, unless the above Detailed Description section explicitly defines such terms. Accordingly, the actual scope of the invention encompasses not only the disclosed embodiments, but also all equivalent ways of practicing or implementing the present technology.

I/We claim:

1. A snatch roller fairlead assembly for mining equipment, comprising:
a fairlead frame comprising—
a first upper support plate;
a first lower support plate spaced apart from the first upper support plate;
a first web having a first end portion coupled to the first upper support plate and a second end portion coupled to the first lower support plate;
a second upper support plate spaced apart from the first upper support plate;
a second lower support plate spaced apart from the second upper support plate; and
a second web having a first end portion coupled to the second upper support plate and a second end portion coupled to the second lower support plate;
a mounting subassembly coupled to the fairlead frame, wherein the mounting subassembly is configured to attach the fairlead frame to a portion of the mining equipment; and
a roller set carried by the fairlead frame and configured to receive a cable, the roller set comprising—
a first control roller rotatably coupled between the first and second webs and positioned proximate the first and second support plates;
a second control roller rotatably coupled between the first and second webs and positioned proximate the first and second lower support plates, wherein the first and second control rollers are spaced apart by a distance to receive the cable therebetween and rotate to allow bidirectional movement of the cable;
a first side roller rotatably coupled between the first upper support plate and first lower support plate; and
a second side roller rotatably coupled between the second upper support plate and second lower support plate, wherein the first and second side rollers are configured to restrict lateral movement of the cable.

2. The assembly of claim 1 wherein the roller set further comprises:
a third side roller rotatably coupled between the first upper and first lower support plates, wherein the first web is positioned between the first and third side rollers; and
a fourth side roller rotatably coupled between the second upper and second lower support plates, wherein the second web is positioned between the second and fourth side rollers.

3. The assembly of claim 1 wherein at least a portion of the fairlead frame is made from structural steel.

4. The assembly of claim 1 wherein the upper control roller, the lower control roller, the first side roller, and/or the second side roller are made from ultra-high molecular weight polyethylene (UHMW).

5. The assembly of claim 1 wherein the upper control roller, the lower control roller, the first side roller, and/or the second side roller are made from steel.

6. The assembly of claim 1 wherein the upper control roller, the lower control roller, the first side roller, and/or the second side roller comprise a surface at least partially coated with a wear-resistant material.

7. The assembly of claim 1 wherein the first side roller comprises:
a first end portion coupled to a first bearing retained within an upper bearing bracket coupled to the first upper support plate, the first end portion having a first transition portion to provide clearance between the first side roller and the upper bearing bracket; and
a second end portion coupled to a second bearing retained within a second bearing bracket coupled to the first lower support plate, the second end portion having a second transition portion to provide clearance between the first side roller and the lower bearing bracket.

8. The assembly of claim 1 wherein:
the fairlead frame further comprises a base plate coupled to the first and second upper support plates; and
the mounting subassembly comprises a hoist ring component coupled to the base plate, wherein the hoist ring component is configured to rotate relative to the fairlead frame.

9. The assembly of claim 1 wherein the mounting subassembly comprises:
a mounting component configured to suspend the fairlead frame from the portion of the mining equipment; and
a hoist ring component having a first end portion coupled to the mounting component and a second end portion coupled to the fairlead frame.

10. A cable routing system, comprising:
a cable having a first end configured to be coupled to a stationary portion of a mining shovel and a second end configured to be coupled to a movable bucket of the mining shovel; and
a snatch roller fairlead assembly configured to be coupled between the stationary portion and the movable bucket, wherein the snatch roller fairlead assembly comprises:
a fairlead frame including:
a base plate;
an upper support plate coupled to a lower side of the base plate;
a lower support plate spaced apart from the upper support plate;
a web coupled and extending between the upper support plate and the lower support plate;
a roller set coupled to the fairlead frame, the roller set including:
a first control roller rotatably coupled to the web and positioned proximate to the upper support plate;
a second control roller rotatably coupled to the web and positioned proximate to the lower support plate; and
a side roller rotatably coupled between the upper and lower support plates;
wherein the cable is configured to extend between the upper and lower control rollers and adjacent to the side roller.

11. The system of claim 10 wherein the snatch roller fairlead assembly further comprises a mounting subassembly coupled to the fairlead frame, wherein the mounting subassembly is configured to attach the fairlead frame to the mining shovel.

12. The system of claim 10 wherein the cable is an electrical cable configured to be operatively coupled to transfer power and/or signals to/from an electrical component.

13. The system of claim 12 wherein the electrical component includes a sensor configured to measure characteristics in the movable bucket of the mining shovel.

14. The system of claim 10 wherein the cable comprises a braided cable sleeving made from steel.

15. The system of claim 10 wherein the upper support plate is a first upper support plate, wherein the lower support plate is a first lower support plate, wherein the web is a first web, wherein the side roller is a first side roller, wherein the fairlead frame further includes:
a second upper support plate coupled to a lower side of the base plate and spaced apart from the first upper support plate;
a second lower support plate spaced apart from the second upper support plate; and
a second web coupled and extending between the second upper support plate and the second lower support plate,
wherein the roller set further includes a second side roller rotatably coupled between the second upper and second lower support plates, and
wherein the cable is configured to extend between the first and second side rollers.

16. A method of routing a cable, comprising:
mounting a snatch roller fairlead assembly to a mining shovel, wherein the snatch roller fairlead assembly includes:
a first web;
a second web spaced apart from the first web.
a first control roller rotatably coupled between the first and second webs;
a second control roller rotatably coupled between the first and second webs and spaced apart from the first control roller;
a first side roller extending parallel and proximate to the first web; and
a second side roller extending parallel and proximate to the second web; and
routing a cable between the first and second control rollers and between the first and second side rollers.

17. The method of claim 16 wherein the mining shovel includes a bucket, wherein the cable includes an electrical cable, the method further comprising:
operatively coupling the cable to an electrical component mounted on the bucket; and
transferring power and/or signals to/from the electrical component through the cable.

18. The method of claim 16 wherein the cable includes a braided cable sleeving, and wherein the first control roller, the second control roller, the first side roller, and/or the second side roller is at least partially coated with a wear-resistant material.

19. The method of claim 16, further comprising:
moving the cable through the snatch roller fairlead assembly, thereby causing at least one of the first control roller, the second control roller, the first side roller, or the second side roller to roll against the cable.

20. The method of claim 16 wherein the snatch roller fairlead assembly further comprises a mounting subassembly coupled to the fairlead frame, wherein the mounting subassembly is configured to attach the first web to the mining shovel.
